(19) United States
(12) Patent Application Publication
(10) Pub. No.: US 2020/0133201 A1
(43) Pub. Date: Apr. 30, 2020

(54) CLOCK

(71) Applicant: Kyung Hwan LEE, Gyeonggi-do (KR)

(72) Inventor: Kyung Hwan LEE, Gyeonggi-do (KR)

(21) Appl. No.: 16/224,316

(22) Filed: Dec. 18, 2018

(30) Foreign Application Priority Data
Oct. 25, 2018 (KR) 20-2018-0004857

(51) Int. Cl. G04B 19/20; G04B 45/00; G04B 45/02

(52) U.S. Cl. CPC G04B 19/207; G04B 45/02; G04B 45/0069

(57) ABSTRACT

Disclosed herein is a clock. The clock includes: a first belt; an hour axis unit comprising first and second rotation axis spaced apart from each other by a predetermined distance and being rotable; and an hour hand configured to point a position of the hour axis unit, wherein the first belt makes revolutions by being engaged with the first and second rotation axis.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application claims priority from Korean Utility Model Application No. 20-2018-0004857 filed on Oct. 25, 2018 in the Korean Intellectual Property Office, and all the benefits accruing therefrom under 35 U.S.C. § 119, the disclosure of which is incorporated herein by reference in its entirety.

### BACKGROUND

### 1. Field of the Disclosure

The present disclosure relates to a clock, more specifically to a clock that provides time information in such a manner that an hour hand and a minute hand do not move while numbered belts make revolutions.

### 2. Description of the Related Art

A clock is an instrument used to measure, keep, and indicate time. There are a variety of clocks depending on their purposes, such as a portable watch that allows a person to carry it to see time, a desk clock or wall clock that is installed at a place to allow many people to see it, and an industrial clock used to determine the work process at a factory and the like. Such clocks indicate time in a variety of ways.

Generally, a clock that can display a date uses the hour hand, the minute hand and the second hand. Unfortunately, it may not be easy for a user to intuitively see what time it is from such a clock.

### SUMMARY

Aspects of the present disclosure provide a clock with fixed hour hand and minute hand, to allow a user to intuitively see what time it is.

Aspects of the present disclosure also provide a clock that operates multi-dimensionally and dynamically to improve the aesthetic quality.

According to some aspects of the present disclosure, there is provided a clock comprising a first belt; an hour-axis unit comprising first and second rotation axis spaced apart from each other by a predetermined distance and being rotable and an hour hand configured to point a part of the hour axis unit, wherein the first belt makes revolutions by being engaged with the first and second rotation axis.

According to some aspects of the present disclosure, there is provided a clock comprising a first belt having a front part thereof an hour axis unit comprising first to third rotation axis spaced apart from one another by a predetermined distance and being rotable and an hour hand being fixed and configured to point a part of the hour axis unit, wherein the first to third rotation axis are spaced apart from one another to form a triangle, and wherein the first belt is connected to the first to third rotation axis in a Möbius strip shape.

This and other aspects, embodiments and advantages of the present disclosure will become immediately apparent to those of ordinary skill in the art upon review of the Detailed Description and Claims to follow.

### DESCRIPTION OF THE DRAWINGS

The above and other aspects and features of the present disclosure will become more apparent by describing in detail exemplary embodiments thereof with reference to the attached drawings, in which:

FIG. 1 is a view showing a clock according to some exemplary embodiments of the present disclosure.

FIG. 2A is a view showing an hour axis unit in a clock according to some exemplary embodiments of the present disclosure.

FIG. 2B is a view showing an hour axis unit in a clock according to some exemplary embodiments of the present disclosure.

FIG. 3 is a view showing a belt according to some exemplary embodiments of the present disclosure.

FIG. 4 is a view showing an hour axis unit in a clock according to some exemplary embodiments of the present disclosure.

FIG. 5 is a view showing a clock according to some exemplary embodiments of the present disclosure.

FIG. 6 is a view showing a clock according to some exemplary embodiments of the present disclosure.

### DETAILED DESCRIPTION

It will be understood that when an element or layer is referred to as being “on” or “connected to” another element or layer, it can be directly on or connected to the other element or layer or intervening elements or layers may be present. In contrast, when an element It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present inventive concept.

The present inventive concept will be described with reference to perspective views, cross-sectional views, and/or plan views, in which preferred embodiments of the inventive concept are shown. Thus, the profile of an exemplary view may be modified according to manufacturing techniques and/or allowances. That is, the embodiments of the inventive concept are not intended to limit the scope of the present inventive concept but cover all changes and modifications that can be caused due to a change in manufacturing process. Thus, regions shown in the drawings are illustrated in schematic form and the shapes of the regions are presented simply by way of illustration and not as a limitation.

Unless defined otherwise, all technical and scientific terms used herein have the same meaning as commonly understood by one of ordinary skill in the art to which this inventive concept belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

Is referred to as being “directly on” or “directly connected to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present inventive concept.

The present inventive concept will be described with reference to perspective views, cross-sectional views, and/or plan views, in which preferred embodiments of the inventive concept are shown. Thus, the profile of an exemplary view may be modified according to manufacturing techniques and/or allowances. That is, the embodiments of the inventive concept are not intended to limit the scope of the present inventive concept but cover all changes and modifications that can be caused due to a change in manufacturing process. Thus, regions shown in the drawings are illustrated in schematic form and the shapes of the regions are presented simply by way of illustration and not as a limitation.

Unless defined otherwise, all technical and scientific terms used herein have the same meaning as commonly understood by one of ordinary skill in the art to which this inventive concept belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

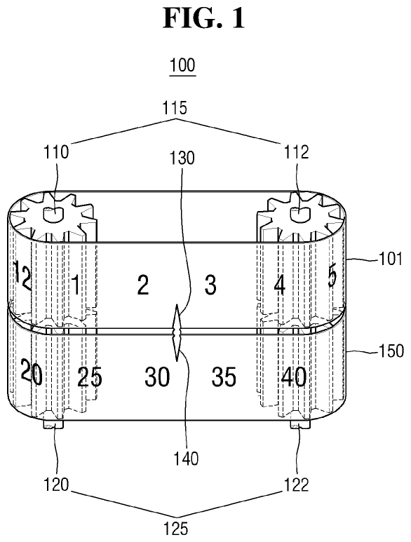

FIG. 1 is a view showing a clock according to some exemplary embodiments of the present disclosure.

Referring to FIG. 1, a clock 100 includes a first belt 101, a second belt 150, first to fourth rotation axis 110, 112, 120 and 122, an hour axis unit 115, a minute axis unit 125, an hour hand 130, and a minute hand 140.

The numerals from 1 to 12 may be marked on the first belt 101 in this order. The numerals from 1 to 24 may be marked on the first belt 101 in this order. The numerals marked in the first belt 101 may be Roman numerals instead of Arabic numerals. It is to be noted that the numerals are not limited thereto but may be marked in various shapes representing numerals. The numerals of the first belt 101 are marked in the order from 1 to 12. However, the numerals are not limited thereto but may be marked, for example, in the order of 1, 3, 5, 7, 9, 12.

The first belt 101 may make revolutions as it is engaged with the first and second rotation axis 110 and 112 spaced apart from each other at a predetermined distance. The first and second rotation axis 110 and 112 may form the single hour axis unit 115.

The first and second rotation axis 110 and 112 are not limited to gear wheels but may be in the form of a rotatable cylindrical shape. It is, however, to be understood that the present disclosure is not limited thereto.

The numerals from 0 to 60 may be marked on the second belt 150 in this order. In addition, the numerals marked in the second belt 150 may be Roman numerals instead of Arabic numerals. It is to be noted that the numerals are not limited thereto but may be marked in various shapes representing numerals. The numerals of the second belt 150 are marked in the order from 0 to 60. However, the numerals are not limited thereto but may be marked, for example, in the order of 0, 5, 10, . . . , 55, 60.

The second belt 150 may make revolutions as it is engaged with the third and fourth rotation axis 120 and 122 spaced apart from each other at a predetermined distance. The third and fourth rotation axis 120 and 122 may form the single minute axis unit 125.

The third and fourth rotation axis 120 and 122 are not limited to gear wheels but may be in the form of a rotatable cylindrical shape. It is, however, to be understood that the present disclosure is not limited thereto.

The clock 100 may include the hour hand 130 that indicates a point of the hour axis unit 115 and the minute hand 140 that indicates a point of the minute axis unit 125.

The hour hand 130 and the minute hand 140 are fixed while the hour axis unit 115 and the minute axis unit 125 make revolutions over time, such that a user can read the numerals pointed by the hour hand 130 and the minute hand 140 and thus can intuitively see what time it is. In addition, the clock 100 can have the refined design.

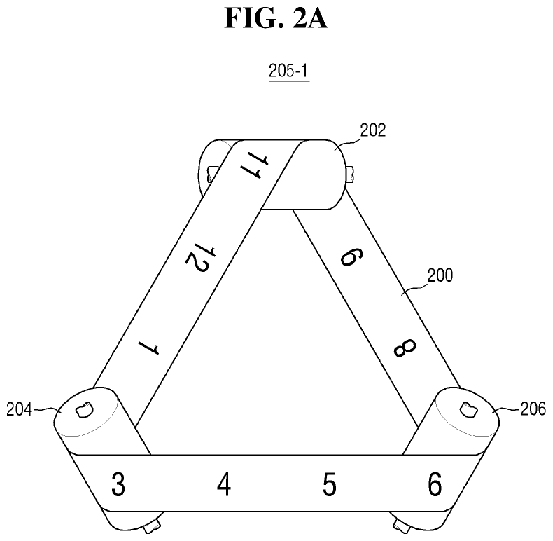

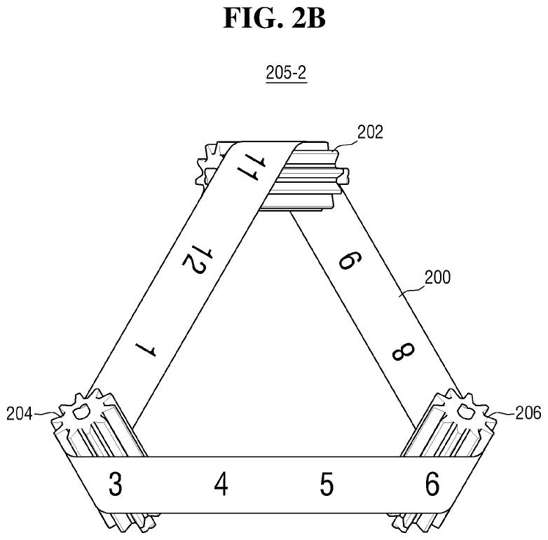

FIG. 2A is a view showing an hour axis unit in a clock according to some exemplary embodiments of the present disclosure.

Referring to FIG. 2A, an hour axis unit 205_1 in a clock includes a first belt 200 and first to third rotation axis 202, 204 and 206.

The numerals from 1 to 12 may be marked on the first belt 200 in this order. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 12. However, the numerals are not limited thereto but may be marked, for example, in the order of 1, 3, 5, 7, 9, 12.

The numerals from 1 to 24 may be marked on the first belt 200 in this order. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 24. However, the numerals are not limited thereto but may be marked, for example, in the order of 1, 3, 5, 7, . . . , 24.

The first belt 200 may make revolutions as it is engaged with the first to third rotation axis 202, 204 and 206 spaced apart from one another at a predetermined distance. The first to third rotation axis 202, 204 and 206 may be spaced apart from one another other to form a triangle. The first belt 200 is connected to the first to third rotation axis 202, 204 and 206 forming the triangle and may be connected in a Möbius strip shape. Accordingly, both the front and rear surfaces of the first belt 200 can be seen as the first to third rotation axis 202, 204, and 206 rotate.

FIG. 2B is a view showing an hour axis unit in a clock according to some exemplary embodiments of the present disclosure.

Referring to FIG. 2B, an hour axis unit 205_1 in a clock includes a first belt 200 and first to third rotation axis 202, 204 and 206.

The numerals from 1 to 12 may be marked on the first belt 200 in this order. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 12. However, the numerals are not limited thereto but may be marked, for example, in the order of 1, 3, 5, 7, 9, 12.

The numerals from 1 to 24 may be marked on the first belt 200 in this order. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 24. However, the numerals are not limited thereto but may be marked, for example, in the order of 1, 3, 5, 7, . . . , 24.

The first belt 200 may make revolutions as it is engaged with the first to third rotation axis 202, 204 and 206 spaced apart from one another at a predetermined distance. The first to third rotation axis 202, 204 and 206 may be spaced apart from one another other to form a triangle. The first belt 200 is connected to the first to third rotation axis 202, 204 and 206 forming the triangle and may be connected in a Möbius strip shape. Accordingly, both the front and rear surfaces of the first belt 200 can be seen as the first to third rotation axis 202, 204, and 206 rotate.

The first to third rotation axis 202, 204 and 206 may include a gear wheel shape.

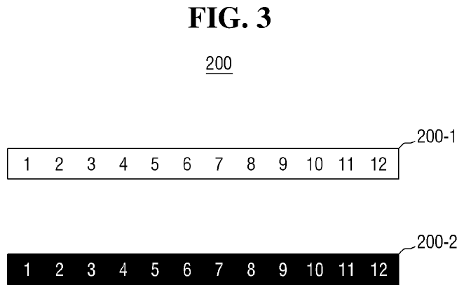

FIG. 3 is a view showing a belt according to some exemplary embodiments of the present disclosure.

Referring to FIGS. 2A and 3, numerals from 1 to 12 are marked on a front part 200-1, which is the front surface of the first belt 200. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 12. However, the numerals are not limited thereto but may be marked, for example, in the order of 1, 3, 5, 7, 9, 12.

The numerals from 1 to 24 may be marked on the first belt 200 in this order. The numerals marked in the first belt 200 may be Roman numerals instead of Arabic numerals. It is to be noted that the numerals are not limited thereto but may be marked in various shapes representing numerals. The numerals of the first belt 200 are marked in the order from 1 to 24. However, the numerals are not limited thereto but may be marked, for example, in the order of 1, 3, 5, 7, . . . , 24.

Similarly to the front part 200-1, a rear part 200-2, which is the rear surface of the first belt 200, may have the numerals from 1 to 12 marked in this order thereon. The numerals marked on the rear part 200_2 of the first belt 200 may be Roman numerals instead of Arabic numerals. It is to be noted that the numerals are not limited thereto but may be marked in various shapes representing numerals. The numerals of the first belt 200 are marked in the order from 1 to 12. However, the numerals are not limited thereto but may be marked, for example, in the order of 1, 3, 5, 7, 9, 12.

On the rear part 200-2, which is the rear surface of the first belt 200, the numerals from 1 to 24 may be marked in this order. The numerals marked on the rear part 200_2 of the first belt 200 may be Roman numerals instead of Arabic numerals. It is to be noted that the numerals are not limited thereto but may be marked in various shapes representing numerals. The numerals of the first belt 200 are marked in the order from 1 to 24. However, the numerals are not limited thereto but may be marked, for example, in the order of 1, 3, 5, 7, . . . , 24.

The numerals may be marked on the front part 200-1 and the rear part 200-2 in the same manner. However, the numerals from 1 to 12 may be marked in different manners on the front part 200-1 and the rear part 200-2.

The colors of the numerals and the background may be, but is not limited to being, inverted from the front part 200-1 to the rear part 200-2.

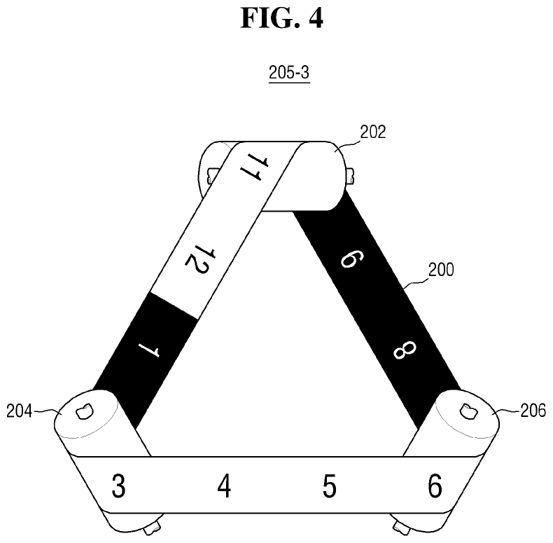

FIG. 4 is a view showing an hour axis unit in a clock according to some exemplary embodiments of the present disclosure.

Referring to FIGS. 3 and 4, an hour axis unit 205_1 in a clock includes a first belt 200 and first to third rotation axis 202, 204 and 206.

In the clock shown in FIG. 4, the colors of the numerals and the background are inverted from the front part 200-1 to the rear part 200-2 of the first belt 200 of the hour axis unit 205-3. As described above with reference to FIG. 2A, the front part 200-1 and the rear part 200-2 of the first belt 200 can be seen as the first to third rotation axis 202, 204 and 206 rotate. Since the colors of the numerals and the background are inverted from the front part 200-1 to the rear part 200-2, the user can easily recognize the current time is in AM or PM. In addition, the clock can provide the refined design.

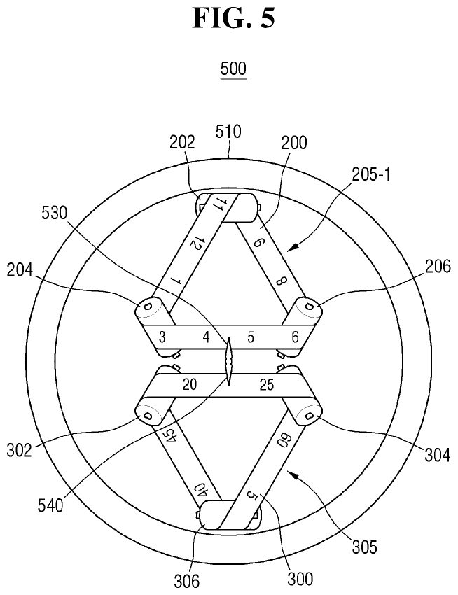

FIG. 5 is a view showing a clock according to some exemplary embodiments of the present disclosure.

Referring to FIG. 5, a clock 500 may include an outer frame 510, an hour axis unit 205-1, an hour hand 530, a minute hand 540, and a minute axis unit 305.

The outer frame 510 may encompass the hour axis unit 205-1, the minute axis unit 305-1, the hour hand 530 and the minute hand 540. The shape of the outer frame 510 may include, but is not limited to, a circular shape.

The outer frame 510 may not be an essential element of the clock 500.

The hour axis unit 205-1 is identical to that of FIG. 2A; and, therefore, the redundant description will be omitted.

The hour axis unit 205-1 in the clock 500 may be the hour axis unit 205-2 in FIG. 2B or FIG. 4.

The minute axis unit 350 may include the second belt 300, and the fourth to sixth rotation axis 302, 304 and 306.

The numerals from 0 to 60 may be marked on the second belt 300 in this order. In addition, the numerals marked in the second belt 300 may be Roman numerals instead of Arabic numerals. It is to be noted that the numerals are not limited thereto but may be marked in various shapes representing numerals. The numerals from 0 to 60 are marked on the second belts 300 in this order. However, the numerals are not limited thereto but may be marked, for example, in the order of 0, 5, 10, . . . , 55, 60.

The second belt 300 may make revolutions as it is engaged with the fourth to sixth rotation axis 302, 304 and 306 spaced apart from one another at a predetermined distance. The fourth to sixth rotation axis 302, 304 and 306 may be spaced apart from one another other to form a triangle. The second belt 300 is connected to the fourth to sixth rotation axis 302, 304 and 306 forming the triangle and may be connected in a Möbius strip shape. Accordingly, both the front and rear surfaces of the second belt 300 can be seen as the fourth to sixth rotation axis 304, 306, and 206 rotate.

The hour hand 530 and the minute hand 540 may be fixed. The hour hand 530 may point a position of the hour axis unit 205-1, and the minute hand 540 may point a position of the minute axis unit 305.

The hour axis unit 115 and the minute axis unit 305 make revolutions over time, such that a user can read the numerals pointed by the hour hand 530 and the minute hand 540 and thus can intuitively see what time it is.

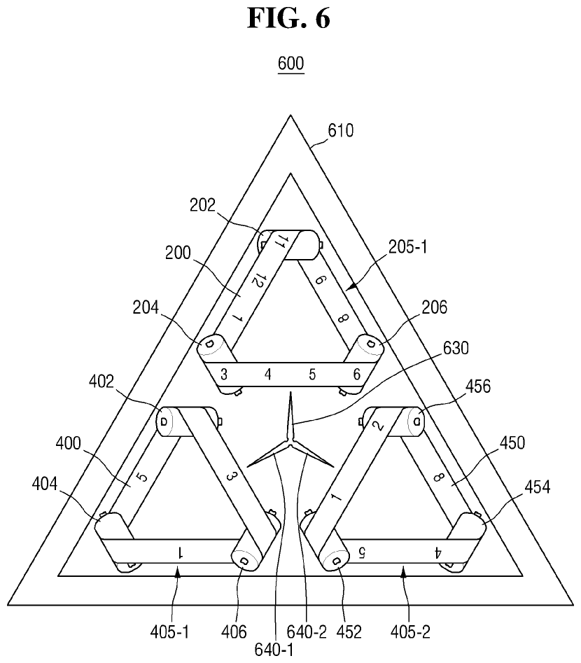

FIG. 6 is a view showing a clock according to some exemplary embodiments of the present disclosure.

Referring to FIG. 6, a clock 600 may include an outer frame 610, an hour axis unit 205-1, a first minute axis unit 405-1, a second minute axis unit 405-2, an hour hand 630, a first minute hand 640-1, and a second minute hand 640-2.

The outer frame 610 may encompass the hour axis unit 205-1, the first minute axis unit 405-1, the second minute axis unit 405-2, the hour hand 630, the first minute hand 640-1, and the second minute hand 640-2. The shape of the outer frame 610 may include, but is not limited to, a triangular shape.

The outer frame 610 may not be an essential element of the clock 600.

The hour axis unit 205-1 is identical to that of FIG. 2A; and, therefore, the redundant description will be omitted.

The hour axis unit 205-1 in the clock 600 may be the hour axis unit 205-2 in FIG. 2B or FIG. 4.

The first minute axis unit 405-1 may include the second belt 400, and the fourth to sixth rotation axis 402, 404 and 406.

The numerals from 0 to 6 may be marked on the second belt 400 in this order. The numerals from 0 to 6 are marked on the second belts 400 in this order. However, the numerals are not limited thereto but may be marked, for example, in the order of 0, 2, 4, 6.

The second belt 400 may make revolutions as it is engaged with the fourth to sixth rotation axis 402, 404 and 406 spaced apart from one another at a predetermined distance. The fourth to sixth rotation axis 402, 404 and 406 may be spaced apart from one another other to form a triangle. The second belt 400 is connected to the fourth to sixth rotation axis 402, 404 and 406 forming the triangle and may be connected in a Möbius strip shape. Accordingly, both the front and rear surfaces of the second belt 400 can be seen as the fourth to sixth rotation axis 402, 404, and 406 rotate.

The second minute axis unit 405-2 may include the third belt 450, and the seventh to ninth rotation axis 452, 454 and 456.

The numerals from 0 to 9 may be marked on the third belt 450 in this order. In addition, the numerals marked in the third belt 450 may be Roman numerals instead of Arabic numerals. It is to be noted that the numerals are not limited thereto but may be marked in various shapes representing numerals. The numerals of the third belts 450 are marked in the order from 0 to 9. However, the numerals are not limited thereto but may be marked, for example, in the order of 0, 3, 6 and 9.

The third belt 450 may make revolutions as it is engaged with the seventh to ninth rotation axis 452, 454 and 456 spaced apart from one another at a predetermined distance. The seventh to ninth rotation axis 452, 454 and 456 may be spaced apart from one another other to form a triangle. The third belt 450 is connected to the seventh to ninth rotation axis 452, 454 and 456 forming the triangle and may be connected in a Möbius strip shape. Accordingly, both the front and rear surfaces of the third belt 450 can be seen as the seventh to ninth rotation axis 454, 456, and 456 rotate.

The hour hand 630, the first minute hand 640-1 and the second minute hand 640-2 may be fixed. The hour hand 630 may point a position of the hour axis unit 205-1, the first minute hand 640-1 may point a position of the first minute axis unit 405-1, and the second minute hand 640-2 may point a position of the second minute axis unit 450-2.

The hour axis unit 205-1, the first minute axis unit 405-1 and the second minute axis unit 450-2 make revolutions over time, such that a user can read the numerals pointed by the hour hand 630, the first minute hand 640-1 and the second minute hand 640-2 and thus can intuitively see what time it is.

That is to say, the first minute hand 640-1 may indicate the first digit of the minute of the current time, and the second minute hand 640-2 may indicate the second digit of the minute of the current time.

Although the exemplary embodiments of the present disclosure have been described with reference to the accompanying drawings, those skilled in the art will readily appreciated that various modifications and alterations may be made without departing from the technical idea or essential features of the present disclosure. Therefore, it should be understood that the above-mentioned embodiments are not limiting but illustrative in all aspects.

It is claimed:

1. A clock comprising:
a first belt;
an hour-axis unit comprising first and second rotation axis spaced apart from each other by a predetermined distance and being rotable; and
an hour hand configured to point a part of the hour axis unit,
wherein the first belt makes revolutions by being engaged with the first and second rotation shafts.

2. The clock of claim 1, further comprising:
a second belt;
a minute axis unit comprising third and fourth rotation axis spaced apart from each other by a predetermined distance and being rotable; and
a minute hand configured to point a part of the minute axis unit,
wherein the second belt makes revolutions by being engaged with the third and fourth rotation axis.

3. The clock of claim 2, wherein numerals from 1 to 24 or a notation for representing hours are marked on the first belt, and
wherein numerals from 1 to 60 or a notation for representing minutes are marked on the second belt.

4. The clock of claim 2, wherein the first to fourth rotation axis are in the form of a gearwheel.

5. A clock comprising:
a first belt having a front part thereof;
an hour axis unit comprising first to third rotation axis spaced apart from one another by a predetermined distance and being rotable; and
an hour hand being fixed and configured to point a part of the hour axis unit,
wherein the first to third rotation axis are spaced apart from one another to form a triangle, and
wherein the first belt is connected to the first to third rotation axis in a Möbius strip shape.

6. The clock of claim 5, further comprising:
a second belt,
a minute axis unit comprising fourth to sixth rotation axis spaced apart from one another by a predetermined distance and being rotable; and
a minute hand being fixed and configured to point a part of the minute axis unit,
wherein the fourth to sixth rotation axis are spaced apart from one another to form a triangle, and
wherein the second belt is connected to the fourth to sixth rotation axis in a Möbius strip shape.

7. The clock of claim 6, wherein numerals from 1 to 24 or a notation for representing hours are marked on the first belt, and
wherein numerals from 1 to 60 or a notation for representing minutes are marked on the second belt.

8. The clock of claim 7, wherein the first to sixth rotation axis are in the form of a gearwheel.

9. The clock of claim 5, further comprising:
a second belt on which numerals from 0 to 5 are marked in this order;
a first minute axis unit comprising fourth to sixth rotation axis spaced apart from one another by a predetermined distance and being rotatable;
a third belt on which numerals 0 to 9 are marked in this order;
a second minute axis unit comprising seventh to ninth rotation axis spaced apart from one another by a predetermined distance and being rotatable;
a first minute hand configured to point a part of the first minute axis unit; and
a second minute hand configured to point a part of the second minute axis unit,
wherein the fourth to sixth rotation axis are spaced apart from one another to form a triangle,
wherein the seventh to ninth rotation axis are spaced apart from one another to form a triangle,
wherein the second belt is connected to the fourth to sixth rotation axis in a Möbius strip shape, and
wherein the third belt is connected to the seventh to ninth rotation axis in Möbius strip shape.

10. The clock of claim 9, wherein the first to ninth rotation axis are in the form of a gearwheel.

11. The clock of claim 5, wherein the first belt has a rear part thereof,
wherein numerals from 1 to 12 are marked on the rear part in this order,
wherein the rear part faces away from the front part, and
wherein colors of the numerals and background of the rear part are different from those of the front part.
